(19) United States
(12) Patent Application Publication
(10) Pub. No.: US 2019/0225014 A1
(43) Pub. Date: Jul. 25, 2019

(54) HUB

(71) Applicant: DT SWISS INC., Grand Junction, CO (US)

(72) Inventors: Martin WALTHERT, Aarberg (CH); Stefan SPAHR, Lengnau (CH)

(21) Appl. No.: 16/256,095

(22) Filed: Jan. 24, 2019

(30) Foreign Application Priority Data
Jan. 25, 2018 (DE) 102018101725.1

(51) Int. Cl. B60B 27/04; B60B 27/02; F16D 41/24

(52) U.S. Cl. CPC B60B 27/047; B60B 27/023; F16D 41/24; B60B 2900/311; B60B 2360/10; B60B 2360/341; B60B 2900/111; B60B 2360/102

(57) ABSTRACT

A hub for bicycles including a hub axle, a hub shell, a rotor, and a toothed disk freewheel including a pair of interacting freewheel components namely, a hub-side freewheel component and a rotor-side freewheel component. The freewheel components each include axial engagement components for intermeshing with one another and are biased in the engagement position through a biasing device. The hub-side freewheel component is axially displaceably received in a threaded ring and is non-rotatably coupled with the hub shell in the driving direction. The rotor-side freewheel component is non-rotatably provided at the rotor for transmitting rotational movement from the rotor to the hub shell in the engagement position of the two freewheel components. The threaded ring is provided with a multiple thread and is screwed to a multiple thread of the hub shell.

### BACKGROUND

The present invention relates to a hub for at least partially muscle-powered vehicles, and in particular two-wheeled vehicles and preferably bicycles, the hub comprising a hub shell which is rotatably supported relative to a hub axle in particular by way of two roller bearings disposed on opposite end regions of the hub shell. The hub comprises a rotor for non-rotatable arrangement of at least one sprocket, the rotor being in particular rotatably supported relative to the hub axle by means of at least two rotor bearings. A freewheel is provided between the rotor and the hub shell.

Other than in bicycles, the hub may be used in other partially muscle-powered vehicles and two-wheeled vehicles which are for example provided with an electric auxiliary drive. The hub is in particular used in sports bicycles. In all the configurations, the hub according to the invention is employed in vehicles and in particular bicycles which in normal and regular proper use are at least partially muscle-powered.

Hubs for bicycles are exposed to high and highest loads in particular in the field of sports and in semi-professional and also professional uses. A general problem with the freewheels of bicycle hubs is to ensure the function with a wide variety of rotational speeds. Proper functioning must be ensured both in very low speeds and in very high speeds.

Furthermore, the freewheel of a bicycle hub must be able to reliably transmit rotational forces as high as those occurring in sports cars. The surface pressures occurring in bicycles may even be higher still since smaller dimensions are involved.

When applying driving force, the freewheel must very quickly and reliably establish force closure, while on the other hand the freewheel is expected to only show minor friction in back-pedaling or non-pedaling. When riding uphill or e.g. when high acceleration is involved, high dynamic loads act on the hub such that each of the components of the hub and the hub on the whole must be regarded in terms of dynamics. For example, in the case of high loads the axle may bend even if the axle is configured as rigid as possible by means of structural measures and the materials employed.

In the prior art different freewheels have been disclosed. A rear wheel hub offering ease of handling in mounting and maintenance has become known in DE 198 47 673 A1. In this hub, torque is transmitted through a pair of toothed disks provided with axial, meshing toothing at their adjacent side faces. The torque applied is reliably transmitted in the driving direction while in the opposite rotational direction the toothed disks axially diverge from one another, thus allowing freewheeling. One of the toothed disks is axially displaceably accommodated in the rotor and the other of the toothed disks, axially displaceably in the hub shell. Since the hub shell tends to consist of a light metal, a threaded ring of steel is screwed into the hub shell in which the toothed disk is axially displaceably guided. This protects the hub shell from direct contact with the toothed disk. It is a drawback though that the loads generated during pedaling drive the threaded ring into the hub shell. This subjects the hub shell to locally high loads so that the hub shell may dilate and even burst in the region of the threaded ring. To prevent this, the wall thickness of the hub shell is increased such that the generated loads can be reliably dissipated. However, this increases the total weight.

It is therefore the object of the present invention to provide a hub which is in particular lighter in weight and stiffer and which provides for structurally minor or minute deformation in operation.

### SUMMARY

A bicycle component according to the invention is provided for at least partially muscle-powered vehicles, and in particular two-wheeled vehicles and preferably bicycles, and comprises a hub axle and a hub shell, a rotor and a freewheel, the freewheel having two interacting freewheel components namely, a hub-side freewheel component and a rotor-side freewheel component. The two freewheel components each comprise axial engagement components for intermeshing with one another and are biased in the engagement position via a biasing device. The two freewheel components are movable relative to one another in the axial direction at least between a freewheel position and the intermeshing engagement position. The hub-side freewheel component is axially displaceably accommodated in a threaded ring through which it is non-rotatably coupled with the hub shell. The rotor-side freewheel component is provided non-rotatably at the rotor to transmit rotational movement from the rotor to the hub shell in the engagement position of the two freewheel components. The threaded ring has a multiple thread and is screwed to a multiple thread of the hub shell.

The hub according to the invention has many advantages. The hub according to the invention in particular allows a lighter weight and a stiffer architecture. A considerable advantage is achieved by providing a multiple thread having at least two thread grooves for the screwed connection between the hub shell and the hub-side freewheel component. The hub shell and the hub-side freewheel component are screwed to one another, wherein the hub shell thread and/or the hub-side freewheel component thread are each provided with at least two separate, axially spaced apart thread grooves. This construction enables an increased thread groove gradient compared to a single thread. The gradient angle is larger and thus the axial force effective in the screwed state is lower. Thus, the axial pressure exerted on the hub shell by the threaded ring urging into the hub shell is reduced. Due to the increased gradient, the axial force is considerably reduced over the prior art. This applies generally, not only for single threads. The entire axial force of the two thread grooves, which must be summed up, is lower than the axially acting force in the case of one single thread groove showing the same pitch. It has been found that in a real construction the acting axial force is noticeably reduced.

In operation, the driving torque basically urges the hub-side freewheel component ever farther into the hub shell so that the driving forces result in increasing pressure on the hub shell and within the hub shell. This results in possible local deformation of the prior art hub shell due to the occurring loads. In the prior art, this could result in the hub shell breaking in the case of defective or too narrow dimensions. The present invention offers the considerable advantage of a reduction of the acting axial forces. A double-pitch (or triple-pitch) or “n”-pitch thread doubles (triples) the gradient angle or multiplies it by “n” while the pitch remains unchanged. Overall, the forces acting axially inwardly into the hub shell in the axial direction are considerably lower so that no hub shell deformation or at least noticeably reduced deformation occurs given the same wall thicknesses. The wall thickness may be reduced while concurrently increasing safety. The forces deforming the hub shell are smaller.

The self-retention is reduced which is again advantageous regarding loads. The self-retention of the thread is still sufficient though so that autonomous detaching need not be feared. Moreover, detaching for maintenance is considerably easier when removing or exchanging, thus unscrewing, the threaded ring.

Overall, the invention reduces the total weight and aerodynamic drag due to a feasible reduced outer hub diameter while the stability under load increases.

Preferably, the threaded ring consists of a stronger material than does the hub shell. Preferably, the hub shell is formed of a material weighing less than the threaded ring. Preferably, the hub shell consists at least partially or entirely of a light metal alloy such as e.g. aluminum alloy and/or magnesium alloy and/or lightweight materials such as carbon and/or fiber-reinforced plastic.

In advantageous specific embodiments, the threaded ring is configured with a multiple external thread and the hub shell, with a multiple internal thread which are screwed to one another when mounted. Particularly preferably, the threaded ring is substantially or nearly entirely or entirely screwed into the hub shell. Alternately, it is conceivable for the threaded ring to show multiple internal threads for screwing onto a matching external thread of the hub shell.

Preferably, a thread groove of at least one of the multiple threads and in particular both of the multiple threads shows a gradient of at least 1.5 mm. When using a double thread, each of the thread grooves shows a gradient of 1.5 mm and the pitch is 0.75 mm. Thus, given a gradient that is larger (e.g. 1.5 mm or 2 mm) than in the prior art (e.g. 1 mm) one can still insert a finer thread so as to provide a still better guide for the thread ring in the hub shell. This allows enhanced centering of the freewheel component. Moreover, the axial forces are lower due to the changed geometric conditions.

In other preferred embodiments, a gradient of a thread groove of at least one of the multiple threads and preferably both of the multiple threads is at least 1.8 mm. Given a double thread and a gradient of 1.8 mm the pitch is then 0.9 mm. Given a triple thread the pitch is then 0.6 mm. These examples use a particularly fine thread while the axial forces and also the retention are reduced.

In preferred configurations, a thread groove of at least one of the multiple threads shows a gradient of at least 2.5 mm or 3.0 mm or more. For example, when using three thread grooves in the multiple threads, given a gradient of 3.0 mm the pitch is 1.0 mm. This considerably reduces the axial force with the pitch remaining unchanged.

In preferred configurations the multiple threads show 2, 3, 4 or more separate thread grooves (aligned in parallel).

Preferably, each of the engagement components forms an axial toothing, and particularly preferably at least one of the two freewheel components is configured as a toothed disk. It is also possible to configure both of the freewheel components as toothed disks. The two toothed disks may be identical in configuration or their axial widths may differ.

It is possible and preferred for the toothed disks to show a constant, hollow cylindrical inner diameter. Alternately, it is possible for a cross-section of a freewheel component to show a U- or L-shape. Then, the engagement components are in particular provided at or formed on the radial leg.

In preferred configurations, the freewheel component comprises a non-round outer contour and is non-rotatably and axially displaceably received in a matching non-round inner contour of the threaded ring or the rotor. Such a non-round outer contour of the freewheel component may be polygonal. It is possible and preferred for the non-round outer contour of the freewheel component to be a radial external toothing. Then, the non-round inner contour of the threaded ring is in particular a matching or adapted radial internal toothing. These measures ensure non-rotatable engagement between the freewheel component and the threaded ring or rotor.

The biasing device may be provided with a spring device or several separate spring devices. Preferably the two freewheel components are separately urged toward one another from the outside. Alternately, it is possible to dispose a freewheel component to be immovable in the axial direction and to urge the other of the freewheel components axially against it for biasing the freewheel to the engagement position.

In all the configurations, the biasing device may for example comprise one or more coil springs. It is also possible for the biasing device to bias the freewheel in the engagement position by way of magnetic spring forces.

If the freewheel component that is for example configured as a toothed disk has a solid body including a cylindrical through hole, the biasing device preferably acts on one of the axial ends while the engagement components are configured on the front face of the other of the axial ends.

In the case of freewheel components comprising a sleeve-like axial body section and a washer at the front face of which the engagement components are formed, the biasing device is preferably urged in the axial direction against the radial leg of the freewheel component.

It is possible for the engagement components of the rotor-side freewheel component to be configured as an end toothing on the rotor. Then, the rotor-side freewheel component may be configured integrally with the rotor or be axially fixedly accommodated on the rotor. Then, no axial displacement of the freewheel component relative to the rotor is possible or required in operation.

Further advantages and features of the present invention can be taken from the description of exemplary embodiments which will be discussed below with reference to the enclosed figures.

### BRIEF DESCRIPTION OF THE DRAWINGS

The figures show in:

FIG. 1 a schematic side view of a racing bicycle equipped with a hub according to the invention;

FIG. 2 a schematic side view of a mountain bike equipped with a hub according to the invention;

FIG. 3 a schematic cross-section of a first hub according to the invention;

FIG. 4 an enlarged detail from FIG. 3;

FIG. 5 an exploded view of the toothed disk freewheel of the hub according to FIG. 3; and

FIG. 6 another schematic cross-section of a hub of another exemplary embodiment.

### DETAILED DESCRIPTION

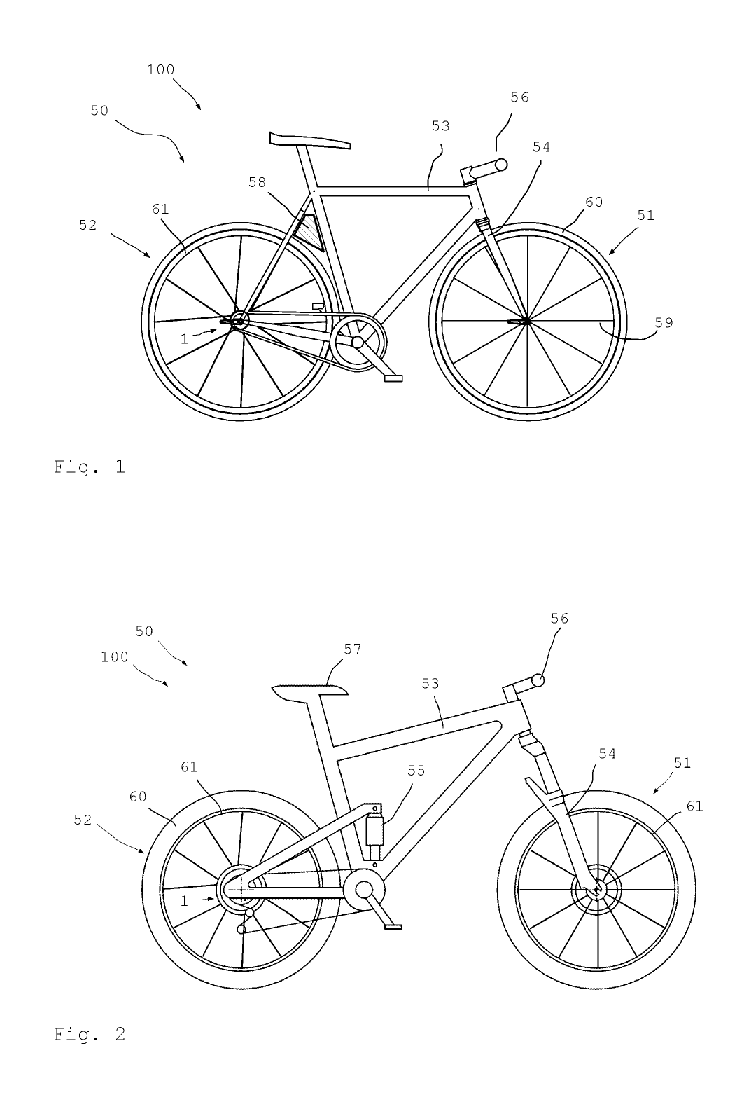

In FIG. 1, a vehicle 100 is illustrated in a schematic side view presently configured as a two-wheeled vehicle 50 and in particular as a racing bicycle. The bicycle 50 is at least partially muscle-powered and may be provided with an electric auxiliary drive.

The racing bicycle is illustrated in a simplistic side view and comprises a front wheel 51, a rear wheel 52 and a frame 53. A handlebar 56 serves as a control and may have different configurations. Apart from a racing handlebar configuration, other known configurations are conceivable as well. Beneath the saddle 57 a battery 58 may be provided which is employed in particular for electro-assisted two-wheeled vehicles. Generally speaking, such a battery 58 may be attached to the frame in other places or incorporated into the frame or received elsewhere.

In the bicycle according to FIG. 1, the tire 60 is configured as a tubeless tire and is for example glued onto the rim 61. The rims 61 of the front wheel 51 and the rear wheel 52 are each connected with the hub via spokes 59. The rear wheel 52 is provided with a hub 1 according to the invention as the rear wheel hub.

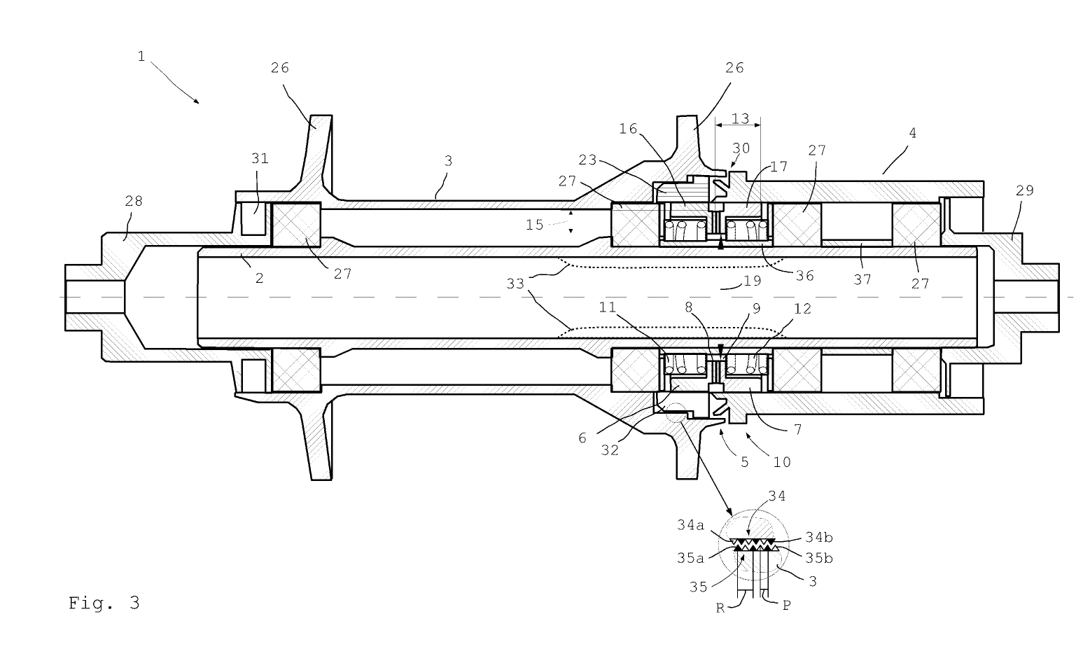

FIG. 2 illustrates a mountain bike as the bicycle 50 in a simplistic side view comprising a front wheel 51, a rear wheel 52, a frame 53, a sprung front fork 54 and a rear wheel damper 55. In this exemplary embodiment, disk brakes are provided. The rear wheel 52 is also provided with a hub 1 according to the invention.

FIG. 3 shows a simplistic cross-section of an inventive hub 1 for a bicycle 50 according to FIG. 1 or FIG. 2.

The hub according to the invention is provided with a hub axle 2 presently configured hollow and a hub shell 3 presently configured one-piece which comprises two hub flanges 26 for fastening the spokes. In other configurations the hub shell 2 may be configured multipart and for example be provided with a separate hub sleeve to which separate hub flanges 26 are fastened. It is also possible to configure the hub as a “straight pull hub” where no conventional hub flanges are provided.

The rotor 4 receives at least one sprocket, and in particular receives a sprocket cluster having multiple sprockets. Selecting a corresponding sprocket allows variation in the driving gear ratio as desired.

The hub shell is supported in the two axial end regions of the hub shell relative to the hub axle 2 through a roller bearing 27. The rotor is likewise supported relative to the hub axle 2 by means of two bearings 27.

A freewheel 5 is provided here which is configured as a toothed disk freewheel. The freewheel transmits the driving torque to the hub shell while, for example in downhill rides or the like a decoupling of the rotational movements of the hub shell and the rotor may occur.

In the illustrated exemplary embodiment, the freewheel 5 is provided with two freewheel components 6 and 7 each provided with axial engagement components 8, 9 which in the engagement position 10 illustrated in FIG. 3 are engaged with one another.

In the exemplary embodiment, the two freewheel components 6, 7 are each configured as a toothed disk 16 or 17, preferably showing identical architecture. The engagement components 8 and 9 each form an axial toothing 18 (cf. FIG. 5) on the front faces of the freewheel components 6, 7 respectively toothed disks 16, 17.

The cross-section of each of the toothed disks is generally about U-shaped, the geometry of the toothed disks 16 and 17 resulting from combining a perforated disk or washer and a sleeve. The axial toothing 18 is provided at the axial front face of the perforated disk.

It is also possible to configure the toothed disks solid and provided with an inner hollow cylindrical aperture. These toothed disks have engagement components (in particular in the shape of teeth) configured on one front face and on the other front face a biasing device 11 or 12 acts for biasing the two freewheel components 6, 7 in the engagement position 10.

The freewheel component 6 configured as a toothed disk 16 is accommodated in the hub component 23 configured as a threaded ring 32 to be axially displaceable and non-rotatable. To this end, the toothed disk 16 comprises an external toothing engaging in a corresponding internal toothing of the threaded ring 32 so as to allow axial movement while prohibiting rotational movement of the toothed disk 16 relative to the threaded ring 32.

One advantage of the separate threaded ring 32 is that the threaded ring 32 is made of a harder and more robust material than the hub shell 3. Since the threaded ring 32 shows a relatively small volume the total weight of the hub is only slightly increased while the service life of the hub is clearly extended.

The radially outside surface of the threaded ring 32 is provided with a multiple thread 34, presently with two separate, axially spaced apart thread grooves 34a and 34b as the enlarged detail shows. The multiple thread 34 of the threaded ring 32 is screwed to a matching multiple internal thread 35 in the hub shell 3. The multiple internal thread 35 comprises two thread grooves 35a and 35b.

The gradient R of the thread grooves of the threads 34 and 35 in this exemplary embodiment is 2.0 mm (or else 3.0 mm), while the pitch P is 1.0 mm (or 1.5 mm). This means that the same pitch “P” shows double the gradient “R” such that the axial forces exerted on the hub shell by the threaded ring in the axial direction are considerably lower than in the prior art where the threaded ring was screwed into the hub shell by a single thread.

The multiple threads basically also reduce retention. Reduced retention is advantageous since in operation the threaded ring keeps driving into the hub shell such that automatic detachment is excluded.

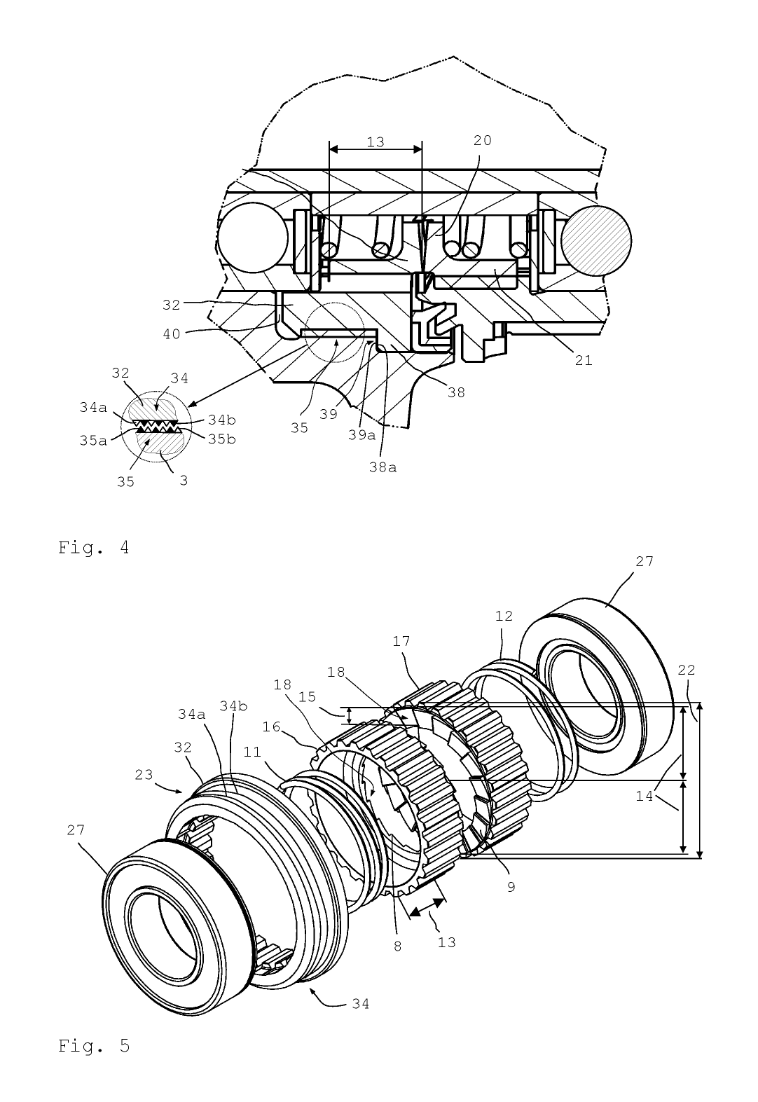

According to the FIGS. 3 and 4, the bearing 27 for supporting the hub shell is radially partially surrounded by the threaded ring 32 on the rotor side. A direct radial contact is not required and is as a rule not present. The threaded ring 32 in particular does not provide a bearing seat. The bearing seat (with correspondingly lower tolerances) is configured in the hub shell 3. It is as a rule provided with a force fit into which the bearing 27 is pressed.

The other of the freewheel components 7 in the present exemplary embodiment is configured as a toothed disk 17, and also comprises a non-round outer contour and in particular an external toothing which is disposed in a corresponding internal toothing of the rotor 4 to be non-rotatable but axially displaceable.

In all the configurations, the rotor and the hub shell are disposed fixedly spaced apart in the axial direction in (normal) operation.

Each of the two toothed disks 16, 17 is urged toward one another in the axial direction by means of a biasing device 11 or 12 configured as a coil spring to have the axial toothings 18 of the two toothed disks engage with one another. In this way, a torque transmission from the rotor to the hub shell 3 is enabled in the driving direction, while in the reversed rotational direction the teeth of the toothed disks 8, 9 are urged away from one another against the force of the biasing devices 11, 12, gliding past one another on their tooth flanks.

For sealing, a seal 30 is provided between the rotor 4 and the hub shell 3 which can presently comprise a contactless labyrinth seal and/or a contacting elastomeric seal to keep moisture and dust and the like away from the freewheel 5.

One of the ends is provided with an adapter ring 28 and the other of the ends with an adapter ring 29 which are pushed onto the hub axle 2 and which at their extreme ends comprise regions suitable to be pushed into the dropouts of a bicycle fork or a bicycle frame. A quick release not illustrated in FIG. 3 may for example serve for fastening. It is likewise possible to use a through axle for fastening wherein the adapter rings 28 and 29 are as a rule not required or not in this shape.

The adapter ring 28 presently comprises a double-flange seal 31 acting as a double labyrinth seal and showing high efficiency. The adapter ring 29 may be configured in analogy and be provided with a double-flange seal.

The bearings 27 used are preferably commercially available roller bearings provided with an outer ring, an inner ring and rolling members disposed in-between. The rolling members are preferably retained by a holding device such as a rolling member cage or the like. Particularly preferably, the axial ends of the roller bearings show seals for protecting the interior of the roller bearing. The seals may be elastomeric seals. The bearings used are preferably deep-groove ball bearings.

A clear inner diameter of the freewheel components 6, 7 is in particular not larger than twice or three times or four times the axial width 13 of the toothed disk 16. This ensures a secure seat of the toothed disk 16 in the threaded ring 32 and prevents possible tilting of the toothed disk 16 in moving back and forth. This will further increase the reliability of the toothed disk freewheel.

For reinforcement, a radial bulge 33 may be provided as is presently illustrated in broken lines. The bulge 33 may be configured inwardly at the hub axle 2. It is also possible to provide the bulge 33 radially outwardly.

The clamping forces in the frame are dissipated by the inner rings of the bearings 27, the sleeves 36 and 37 and by a part of the hub axle 2 into which the clamping force is introduced and outlet through radial bulges on the bearings 27 for supporting the hub shell 3. The clamping forces are outlet at the outwardly ends through the adapter rings 28 and 29.

In the FIGS. 4 and 5, the toothed disk freewheel is illustrated in an enlarged cross-section or in an enlarged, exploded view for better illustration of the details.

FIG. 4 shows the region of the threaded ring 32 in an enlarged illustration. Additionally, and again enlarged, a detail showing the multiple threads 34, 35 in the threaded ring 32 and the hub shell 3 is illustrated. By way of their thread grooves 34a and 34b, the two multiple threads 34, 35 engage the thread grooves 35a and 35a in the hub shell to securely receive the threaded ring 32 in the hub shell. The multiple threads provide for reliable guiding and secure retention of the threaded ring 32 in the hub shell 3.

As can be clearly seen in FIG. 4, the threaded ring shows at its axially outwardly end a slightly enlarged (and here) circumferential flange 38 at the axially inwardly end of which a stopper 38a is formed which rests against a corresponding stopper 39a of a radial shoulder 39 in the hub shell 3. This configuration results in a (narrower) gap 40 remaining at the inner axial end of the threaded ring between the inner axial end of the threaded ring 32 and the body of the hub shell 3. This configuration again contributes to limiting the axial forces acting on the hub shell.

FIG. 5 is an exploded view wherein the outer radius 14 of the axial toothings 18 is not larger than double the axial width 13 of the toothed disks 16, 17. The size of the axial width 13 of the toothed disks 16, 17 is at least 30% or 40% or half the outer radius 14 of the axial toothings 8 respectively 9.

FIG. 5 shows two simplistic thread grooves 34a and 34b on the outer surface of the threaded ring 32 which combined form a multiple thread 34.

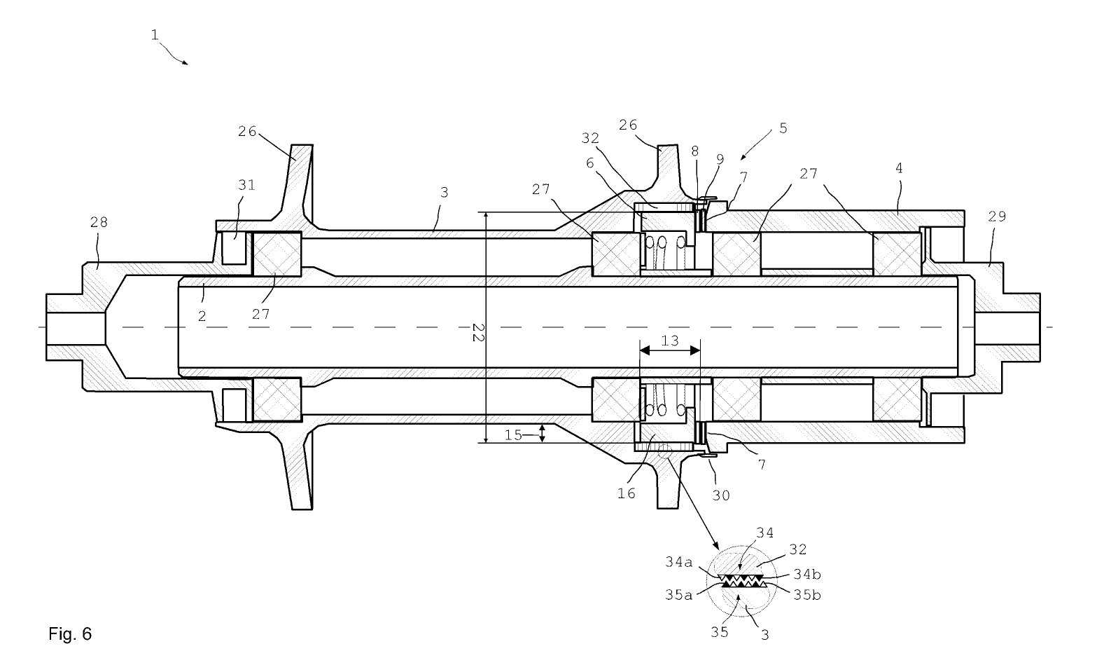

FIG. 6 shows another exemplary embodiment of a hub according to the invention, the architecture of which is substantially the same as that of the hub according to the invention according to FIG. 3. Therefore, like or similar parts are provided with the same reference numerals.

The hub 1 in the exemplary embodiment according to FIG. 6 is provided with a hub axle 2 and a hub shell 3 equipped with hub flanges 26. The hub shell 3 is supported rotatably relative to the hub axle 2 through two bearings 27. The rotor is likewise rotatably supported relative to the hub axle by means of two bearings 27.

Between the hub shell 3 and the rotor 4 a freewheel 5 is provided which in turn comprises freewheel components 6 and 7. A contactless and/or contacting sealing may be provided between the rotor 4 and the hub shell 3.

In this exemplary embodiment, the freewheel components 6 and 7 are not configured identical but differently. While the freewheel component 6 is configured as a toothed disk 16, the freewheel component 7 is configured as an end toothing at (in particular integrally with) one axial end of the rotor. In this way the axial end of the rotor 4 with the axial toothing 18 provided thereat is in engagement with the axial toothing 18 of the toothed disk 16.

The toothed disk 16 is biased in the axial direction toward the rotor 4 by a biasing device 11 presently configured as a coil spring such that the teeth of the axial toothings 18 are as a rule engaged with one another.

In the exemplary embodiment, the bearings 27 provided to support the hub shell 3 adjacent to the toothed disk 16 are for example inserted by means of force fit.

In FIG. 3, a threaded ring 32 for receiving the toothed disk 16 is equipped with a multiple external thread 34 which is screwed with a corresponding multiple internal thread 35 in the hub shell 3.

The enlarged detail beneath FIG. 6 schematically shows the region of the intermeshing multiple threads 34 and 35 wherein for the sake of simplicity two thread grooves are indicated at the threads 34 and 35. Again the gradient of each of the thread grooves 34a, 34b and 35a, 35b is twice that of a single thread. The pitch of the thread remains the same though. This leads to decreased axial loads acting on the hub shell 3 such that the wall thicknesses of the hub shell may be reduced. This reduces the total weight and it is also possible to reduce air drag since, for example the cross-sectional area may be reduced.

On the whole the invention provides an advantageous hub 1 which provides a lower weight combined with increased rigidity and enhanced durability.

While a particular embodiment of the present hub has been described herein, it will be appreciated by those skilled in the art that changes and modifications may be made thereto without departing from the invention in its broader aspects and as set forth in the following claims.

List of reference numerals:

| | |
|---|---|
| 1 | hub |
| 2 | hub axle |
| 3 | hub shell |
| 4 | rotor |
| 5 | freewheel |
| 6 | freewheel component |
| 7 | freewheel component |
| 8 | engagement component |
| 9 | engagement component |
| 10 | engagement position |
| 11 | biasing device |
| 12 | biasing device |
| 13 | axial width |
| 14 | outer radius |
| 15 | radial extension |
| 16 | toothed disk |
| 17 | toothed disk |
| 18 | axial toothing |
| 19 | inner diameter |
| 20 | radial leg |
| 21 | axial leg |
| 22 | outer diameter |
| 23 | hub component |
| 24 | hub component |
| 25 | outer radius |
| 26 | hub flange |
| 27 | bearing |
| 28 | adapter ring |
| 29 | adapter ring |
| 30 | seal |
| 31 | double flange seal |
| 32 | hub component, threaded ring |
| 33 | bulge |
| 34 | thread |
| 34a | thread groove |
| 34b | thread groove |
| 35 | thread |
| 35a | thread groove |
| 35b | thread groove |
| 36 | sleeve |
| 37 | sleeve |
| 38 | flange |
| 38a | stopper |
| 39 | shoulder |
| 39a | stopper |
| 40 | gap |
| 50 | bicycle |
| 51 | front wheel |
| 52 | rear wheel |
| 53 | frame |
| 54 | fork |
| 55 | rear wheel damper |
| 56 | handlebar |
| 57 | saddle |
| 58 | battery |
| 59 | spoke |
| 60 | tire |
| 61 | rim |
| 100 | vehicle |

1. A hub for at least partially muscle-powered vehicles and in particular two-wheeled vehicles having a hub axle and a hub shell and a rotor and a freewheel comprising: a pair of interacting freewheel components namely, a hub-side freewheel component and a rotor-side freewheel component;
wherein the freewheel components each comprise axial engagement components for intermeshing with one another and are biased in the engagement position through at least one biasing device;
wherein the hub-side freewheel component is axially displaceably received in a threaded ring and non-rotatably coupled with the hub shell and wherein the rotor-side freewheel component is non-rotatably provided at the rotor for transmitting rotational movement from the rotor to the hub shell in the engagement position of the two freewheel components; and
the threaded ring is provided with a multiple thread and is screwed to a multiple thread of the hub shell.

2. The hub according to claim 1, wherein the threaded ring consists of a stronger material than does the hub shell.

3. The hub according to claim 1, wherein a multiple outer thread is formed on the threaded ring and a multiple inner thread, on the hub shell which are screwed to one another when mounted.

4. The hub according to claim 1, wherein a thread groove of at least one of the multiple threads shows a gradient of at least 1.5 mm.

5. The hub according to claim 1, wherein a thread groove of at least one of the multiple threads shows a gradient of at least 1.8 mm.

6. The hub according to claim 1, wherein a thread groove of at least one of the multiple threads shows a gradient of at least 2.5 mm or 3.0 mm or more.

7. The hub according to claim 1, wherein the multiple threads show two, three or more separate thread grooves aligned in parallel.

8. The hub according to claim 1, wherein the engagement components form one axial toothing each and wherein at least one of the two freewheel components is configured as a toothed disk.

9. The hub according to claim 1, wherein a cross-section of the freewheel component is configured U- or L-shaped and wherein the radial leg is provided with the engagement components.

10. The hub according to claim 1, wherein the freewheel component has a non-round outer contour and is received in a corresponding non-round inner contour of the threaded ring or of the rotor to be non-rotatable and axially displaceable.

11. The hub according to claim 1, wherein the biasing device is at least partially disposed in the interior of the freewheel component.

12. The hub according to claim 1, wherein the biasing device presses against the radial leg of the freewheel component in the axial direction.

13. The hub according to claim 1, wherein the engagement components of the rotor-side freewheel component is configured as an end toothing at the rotor.

14. The hub according to claim 1, wherein at least one freewheel component and the threaded ring consists of steel and the hub shell consists at least in part of at least one lightweight material such as light metal or a fibrous composite material.
